(19) United States
(12) Patent Application Publication
(10) Pub. No.: US 2011/0185289 A1
(43) Pub. Date: Jul. 28, 2011

(54) PORTABLE TABLET COMPUTING DEVICE WITH TWO DISPLAY SCREENS

(76) Inventor: Yang Pan, Singapore (SG)

(21) Appl. No.: 12/695,177

(22) Filed: Jan. 28, 2010

(51) Int. Cl. G06F 3/00; G06F 1/16

(52) U.S. Cl. 715/753; 361/679.26

(57) ABSTRACT

A portable tablet computing device is disclosed. The device comprises a main display screen on a first planar surface and an auxiliary display screen on a second planar surface. According to the preferred embodiment, the main display screen is of a touchscreen type and is used as the display for the device used as a general purpose computing device. The auxiliary display screen is an e-paper type and is for delivering e-books. The device operated as an e-book consumes much less power with a low power processor and an optimized operation system for the e-book reader. Image sensors are used to detect one of the two planar surfaces facing the user and to switch on one of the two display screens accordingly.

### CROSS-REFERENCE TO RELATED APPLICATIONS

Not applicable.

### BACKGROUND

1. Field of Invention

This invention relates generally to a portable computing device. More specifically, the invention describes a portable tablet computing device with two display screens for use as a general purpose computing device and as an e-book with low power consumption.

2. Description of Prior Art

In general terms, tablet computer refers to a slate shaped portable computing device, equipped with a touch-screen. A user operates the device by the use of his or her finger or a stylus. An exemplary tablet computer is the iPad from Apple Inc., Cupertino, Calif.

This form factor offers a more mobile way to interact with a computer. The tablet computing device is a general purpose computing device without a keyboard. The device may be employed to deliver a media asset such as a video clip or an e-book by a media player program. The delivery of media assets in such a manner typically consumes more power than a dedicated media player such as an iPod from Apple for audio and video assets or a Kindle for an e-book from Amazon, Seattle, Wash. The e-books delivered by the Kindle using a reflective display screen such as an e-paper, which resembles more to a natural paper than a LCD (Liquid Crystal Display) screen. However, the e-paper type of display is not suitable for using as a display screen for a general purpose computing device because of its slow refreshing rate.

It is therefore desirable to have a tablet computing device that can be used in one way as a general purpose computing device with a touch-screen type of LCD display and in another way as an e-book reader with an e-paper type of display providing a more comfortable way for the user to read the e-book while consuming much less electrical power.

### SUMMARY OF THE INVENTION

It is an object of the present invention to provide a portable tablet computing device with two display screens. The device can be used as a general purpose computing device with a touch-screen type of LCD display. The device can also be used as an e-book reader with an e-paper type of display.

The exemplary tablet computing device has two display screens. The first display screen is on the first planar surface of the device. The second display screen is on the second planar surface of the device. According to the preferred embodiment, the first display screen is of touch-screen type LCD and is served as a main display for the device as a general purpose computing device. The second display screen is of an e-paper type and is served as the display screen for the e-book reader.

According to one implementation, the device is an integration of a tablet computer and an e-book. A switch is used to switch the operation mode of the device as a tablet computer and as an e-book reader. According to another aspect of the present invention, the tablet computer and the e-book reader may share a number of components such as the storage unit and the power supply. The e-book reader may have a dedicated low power processor. The e-book reader may utilize the CPU of the tablet computer operating in a low power mode. The e-book reader may have a simplified dedicated operation system to save the power consumption.

The device may be equipped with a sensory system that senses one of the two planar surfaces facing the user and switches on one of two display screens accordingly.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary tablet computing device with a main display and an auxiliary display;

FIG. 2 is a schematic diagram illustrating the size and position of a display screen is defined by a stylus operated by a user;

FIG. 3 is a schematic diagram illustrating that an auxiliary display screen is used to display a hierarchical user interface for selecting an e-book;

FIG. 4 is a schematic diagram illustrating two different implementations of the tablet computing device;

FIG. 5 is a schematic diagram illustrating functional blocks of an exemplary implementation of the tablet computing device;

FIG. 6 is a flowchart illustrating the operation of the tablet computing device as an e-book reader;

FIG. 7 is a flowchart illustrating a process that the tablet computing device is switched from an e-book reader to a conventional tablet computer.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present invention is based upon a tablet computer. In general terms, tablet computer refers to a slate shaped portable computing device, equipped with a touchscreen. LCD (Liquid Crystal Display) is typically used as the display screen for the tablet computer. A touchscreen is a display that can detect the presence and location of a touch within the display area. The term generally refers to touch or contact to the display of the device by a finger or a stylus.

An e-book is an e-text that forms the digital media asset equivalent of a conventional printed book. An e-book reader is an electronic device that is designed primarily for the purpose of reading digital books using e-paper that is a display technology designed to mimic the appearance of ordinary ink on paper. Unlike a conventional LCD, which uses a backlight to illuminate its pixels, e-paper reflects light like ordinary paper and is capable of holding text and images indefinitely without consuming electrical power, while allowing the image to be changed later.

The present disclosure uses in an exemplary manner a tablet computing device with a LCD as main display on the first planar surface and an e-paper as auxiliary display on the second planar surface. The inventive concept can be applied to other type of display technologies for both the main display and the auxiliary display. Although e-book is used exemplarily, the other media assets such as audio, video and multimedia files may also be displayed using the auxiliary display.

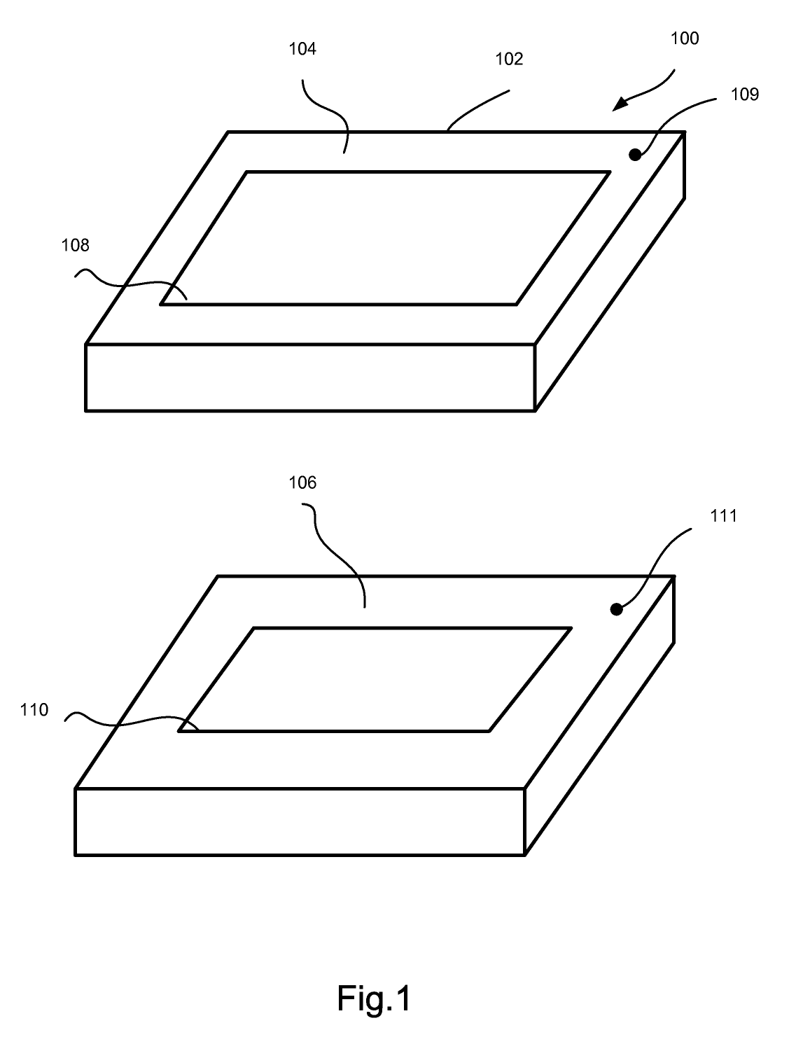

FIG. 1 is a schematic diagram illustrating an exemplary tablet computing device 100. The tablet computing device 100 comprises housing part 102, a top planar surface 104 and a bottom planar surface 106. Electronic components are contained in the housing part 102. The main display 108 is encased on the top surface 104 and the auxiliary display 110 is encased on the bottom surface 106. According to one embodiment of the present invention, the main display 108 is a LCD type of display with touchscreen. The device 100 is used as a tablet computer when the main display 108 is used. The auxiliary display 110 may be an e-paper type of display for reading an e-book by the user.

The e-paper display 110 may be employed to display an image when the display is not being used. A characteristic of e-paper display is that no electrical power is consumed when the displayed image is not changed.

The tablet computing device may further comprise a sensory system for detecting one of the two planar surfaces facing the user. According to one implementation, image sensor 109 and image sensor 111 are installed on the top surface 104 and on the bottom surface 106, respectively. The image sensor detects the surface facing the user and sends the detected signals to a processor of the tablet computing device. The processor controls an operation of switching on one of the two display screens accordingly.

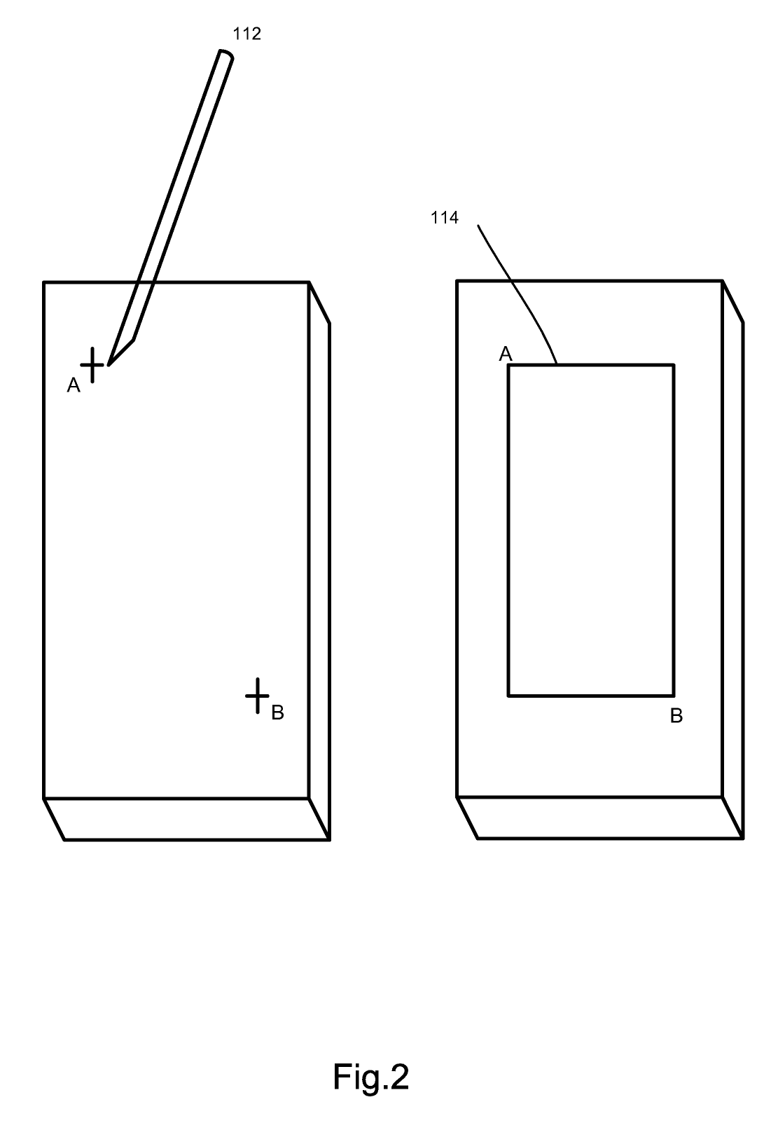

FIG. 2 is a schematic diagram illustrating the size and position of a display screen 110 may be defined by a stylus 112 operated by the user. After a point A and a point B are touched by the stylus 112 in a subsequent manner, the display window 114 is opened with the points: A and B as the diagonal points of a rectangular shape of the screen. The e-paper may occupy whole planar bottom surface of the device according to one implementation. When a display window 114 is opened, the remaining portion of the display using e-paper may continue to display an image, which shows a distinct boundary to the defined display window. The size and position of the window may be adjusted by the user using the stylus or the finger.

According to another implementation of the present invention, the size and position of the display window may also be defined by a user using the main display screen 108 of the device. A specific icon may be actuated by the user of the tablet computer to define the characteristics of the auxiliary display screen using a program.

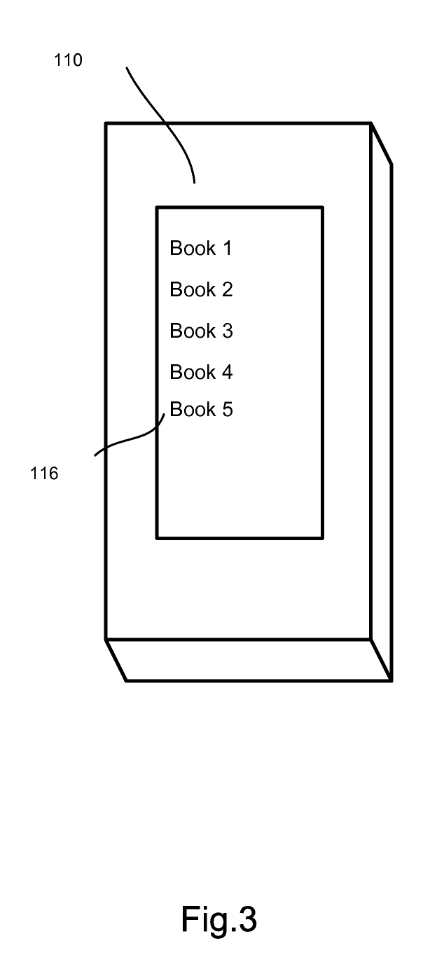

FIG. 3 is a schematic diagram illustrating that an auxiliary display screen is used to display a hierarchical user interface 116 for selecting an e-book. The user may select an e-book for reading by using of the interface in a progressive manner as known in the art.

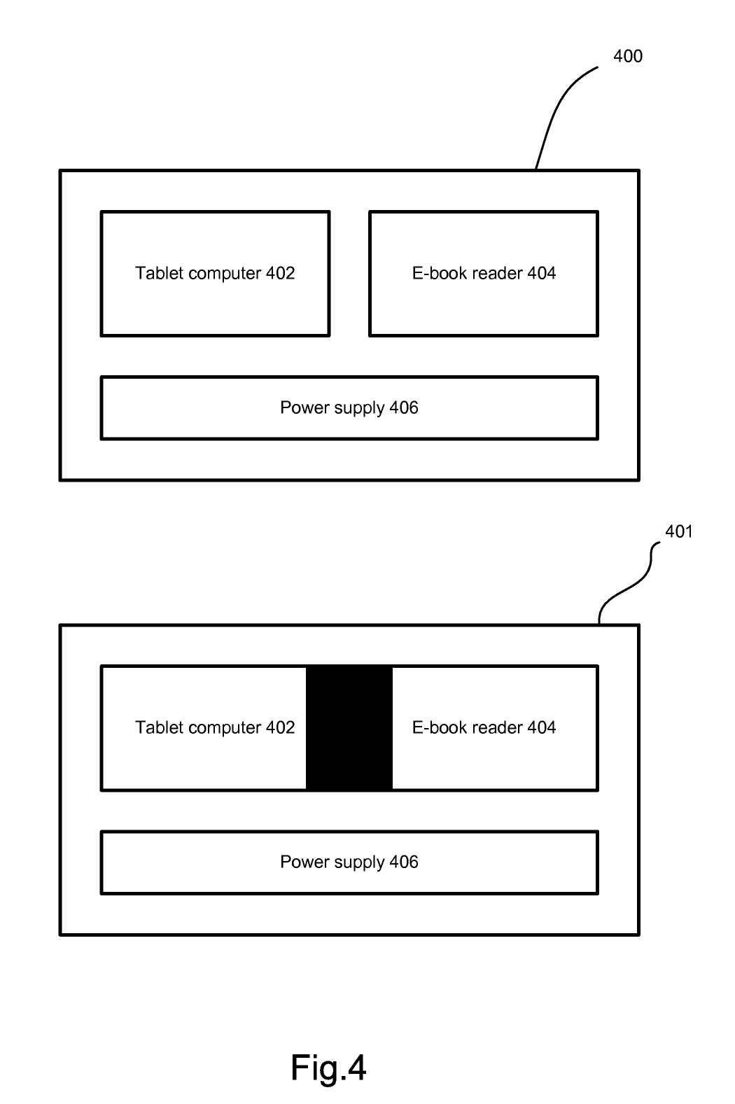

FIG. 4 is a schematic diagram illustrating two different implementations of the tablet computing device. According to one implementation as shown in 400, the device comprises a tablet computer 402 and an e-book reader 404. The unit 402 and the unit 404 may share a power supply 406, which may be a rechargeable battery. 402 and 404 may be two different devices integrated in the same housing part 102. 402 and 404 may have different operation systems.

According to another implementation as shown in 401, the unit 402 and the unit 404 may share some components other than the power supply 406. The shared components may include a storage unit and a signal processing unit. The processor for the e-book reader 404 may be a low power operation mode of the CPU (Central Processing Unit) for the unit 402.

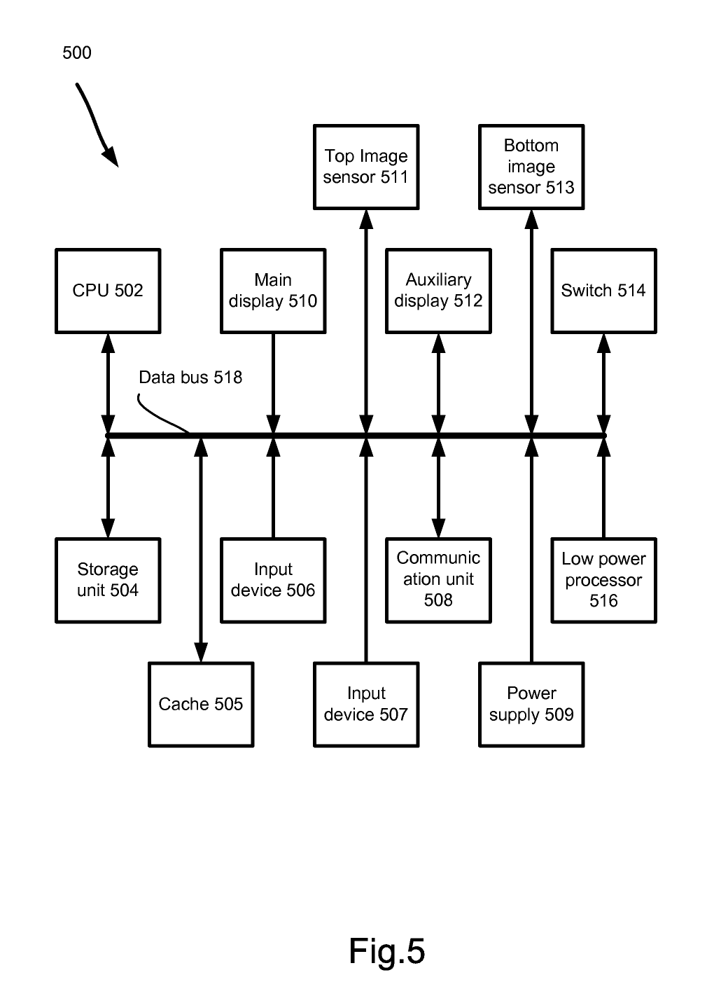

FIG. 5 is a schematic diagram illustrating functional blocks of an exemplary implementation of the device. The tablet computing device 500 comprises a CPU 502 for controlling operations of the device. The device 500 further comprises a storage unit 504 and a cache 505. The storage unit 504 may be one or a plurality of flash memory devices. The storage unit 504 may also be a magnetic storage device. The cache 505 may be a SRAM (Static Random Access Memory) providing a fast access time. The tablet computing device 500 may also include a first input device 506 for the tablet device as a tablet computer. The input device 506 may be located on the top surface of the device. The device may further include another input device 507, which may be located on the bottom surface of the device. A communication unit 508 is used to connect the tablet computing device 500 to a communication network such as the Internet. The communication network may also comprise ad hoc communication networks conforming to various protocols including Bluetooth, ZigBee and WiFi. The power supply 509 provides power for the operations of the device 500. The power supply 509 may be a rechargeable battery.

The tablet computing device 500 further includes two display screens. The main display screen 510 on the top surface of the device is conventional to a tablet computer. 510 may be a LCD type of touchscreen display. The device 500 further comprises an auxiliary display screen 512 on the bottom surface of the device. According to one implementation of the invention, the display screen 512 may be an e-paper type of display for displaying e-books.

According to one implementation, an image sensor 511 is installed on the top surface of the device 500 and another image sensor 513 is installed on the bottom surface of the device. The image sensors are used to sense one of the two surfaces facing the user and send a signal to the processor to switch on one of the two display screens accordingly. The low cost CMOS image sensors are becoming very popular for the mobile devices. The image sensors may also be used as a digital camera for the portable tablet computing devices.

A switch 514 is used to provide a switching means for device to be operated as a tablet computer or as an e-book reader. The low power processor 516 may comprise a processor and a DSP (Digital Signal Processor). The device 500 operated as an e-book reader may consume significantly less power by design. The data bus 518 provides a means for the high speed data transfer.

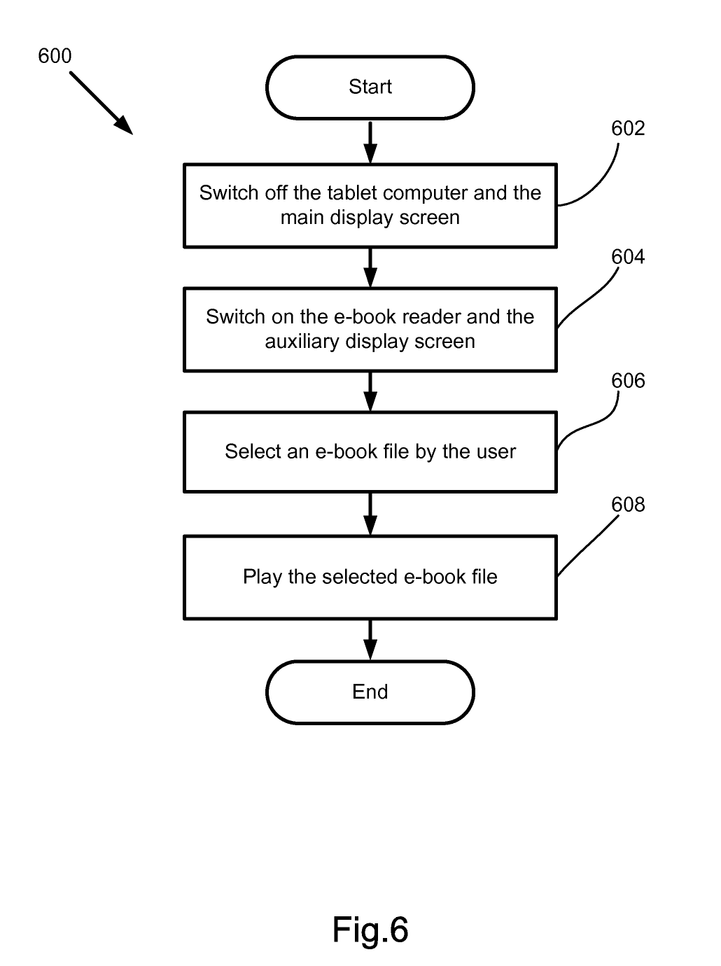

FIG. 6 is a flowchart illustrating the operation of the tablet computing device as a dedicated e-book reader. Process 600 starts with step 602 that the tablet computer and the main display screen are switched off. The switching off operation may be triggered by the image sensor on the bottom surface of the device by sensing the surface facing the user. In step 604, the e-book reader and the auxiliary display screen are switched on. The size and the position of the display screen may be adjusted by the user using a stylus or a finger. A hierarchical user interface as typically used in an e-book reader is displayed and an e-book file is selected by the user in step 606. The selected e-book file is read by the user using the auxiliary display screen in step 608. The e-book files may be stored in the storage unit of the tablet computing device. The e-book files may also be stored in a computing device connected to the device through a communication network such as the Internet. The e-book file may be delivered to the tablet device through the Internet. The e-book files may also be delivered to the user through an ad hoc communication network.

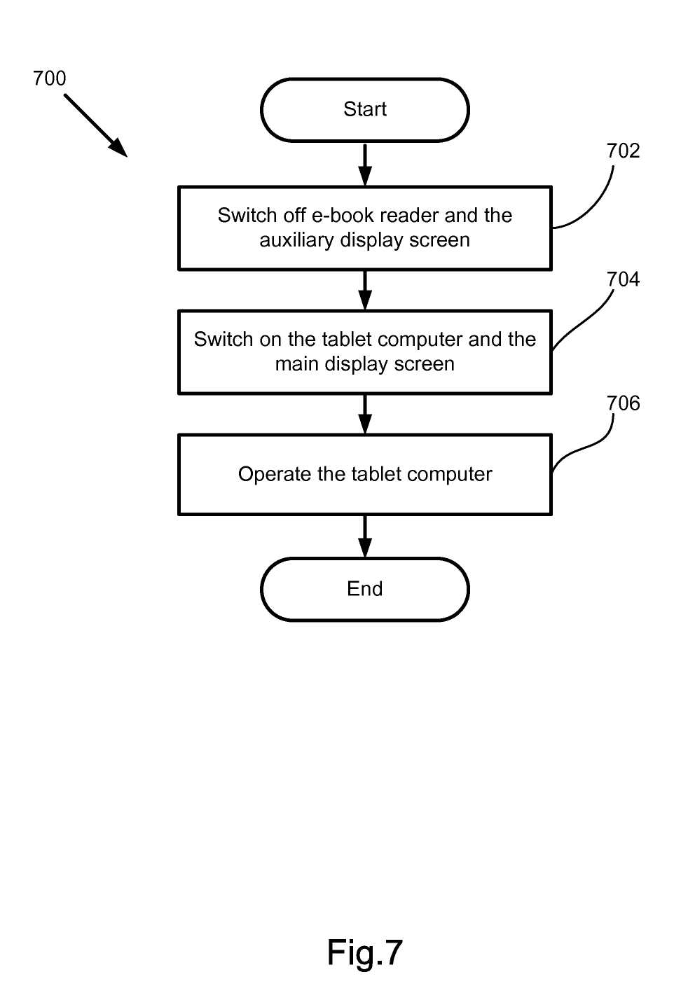

FIG. 7 is a flowchart illustrating a process that the tablet computing device is switched from a dedicated e-book reader to a conventional tablet computer. Process 700 starts with step 702 that the auxiliary display screen and the e-book reader are switched off. In step 704, the tablet computer and the main display screen is switched on. The tablet computing device as a general purpose computing device is then operated in step 706.

While the invention has been disclosed with respect to a limited number of embodiments, numerous modifications and variations will be appreciated by those skilled in the art. It is intended that all such variations and modifications fall with in the scope of the following claims:

1. A tablet computing device comprising:
a. a first display screen of a touch-screen type on a first planar surface; and
b. a second display screen of an e-paper type on a second planar surface,
wherein said first display screen is employed as a main screen for said device as a tablet computer and said second display screen is employed as an auxiliary display screen for an e-book reader.

2. The device as recited in claim 1, wherein said device further comprising:
a. a Central Processing Unit for controlling operations of the device;
b. a storage unit for storing data files including e-book files;
c. a low power processor comprising a means of delivering e-book files by using said second display screen;
d. a communication unit for connecting said device to a communication network; and
e. a power supply for providing power for the operations of the device.

3. The device as recited in claim 2, wherein said low power processor comprising a low power operating mode of said Central Processing Unit.

4. The device as recited in claim 1, wherein said device further comprising a switch for switching operation modes of said device in between the following two modes:
a. a tablet computer using the first display screen; and
b. an e-book reader using the second display screen.

5. The device as recited in claim 1, wherein said device further comprising input devices.

6. The device as recited in claim 1, wherein said device further comprising one image sensor on the first planar surface of the device and another image sensor on the second planar surface of the device, wherein said sensors comprising a means of detecting one of the two planar surfaces facing the user, who is operating the device.

7. The device as recited in claim 1, wherein said e-book reader further comprising a dedicated operation system.

8. The device as recited in claim 1, wherein said device comprising a means of displaying an image by said second display when the device is operated as a tablet computer or when the device is idling.

9. A tablet computing device comprising:
a. a main display screen of a touch-screen type on a first planar surface; and
b. an auxiliary display screen of an e-paper type with a user adjustable size and position on a second planar surface,
wherein said main display screen is used for said device as a tablet computer and said auxiliary display screen is used as a display screen for an e-book reader.

10. The device as recited in claim 9, wherein said auxiliary display screen may occupy whole area of the second planar surface.

11. The device as recited in claim 9, wherein said size and position of the auxiliary display is adjustable by a user using a finger or a stylus.

12. The device as recited in claim 9, wherein said size and position of the second display is adjustable by a user through the use of the tablet computer with the main display screen.

13. The device as recited in claim 9, wherein said device further comprising:
a. a Central Processing Unit for controlling operations of the device;
b. a storage unit for storing data files including e-book files;
c. a low power processor for delivering e-book files by using said auxiliary display screen;
d. a communication unit for connecting said device to a communication network; and
e. a power supply for providing power for the operations of the device.

14. The device as recited in claim 13, wherein said low power processor comprising a low power operating mode of said Central Processing Unit.

15. The device as recited in claim 9, wherein said device further comprising a switch for switching operation modes of said device in between the following two modes:
a. a tablet computer using the main display screen; and
b. an e-book reader using the auxiliary display screen.

16. The device as recited in claim 9, wherein said e-book reader comprising a dedicated operation system.

17. A method of delivering an e-book to a user through the use of a tablet computing device comprising a first display screen on a first planar surface and a second display screen on a second planar surface, the method comprising:
a. switching on the tablet device as an e-book reader operating in a low power mode for delivering e-book files;
b. switching on the second display screen;
c. displaying a user interface in the second display screen with the user selectable items;
d. selecting an e-book file; and
e. playing the selected file.

18. The method as recited in claim 17, wherein said method further comprising switching off the first display screen if an image sensor installed on the second planar surface detects the user is facing said second planar surface.

19. The method as recited in claim 17, wherein said method further comprising a step of switching on the first display screen if an image sensor installed on the first planar surface detects the user is facing said first planar surface.

20. The method as recited in claim 17, wherein said e-book files may be delivered from another computing device connected to the tablet computing device through a communication network, wherein said communication network including the Internet and/or an ad hoc communication network.
